(19) United States
(12) Patent Application Publication
(10) Pub. No.: US 2004/0153313 A1
(43) Pub. Date: Aug. 5, 2004

(54) Method for enlarging the band width of a narrow-band filtered voice signal, especially a voice signal emitted by a telecommunication appliance

(76) Inventors: Roland Aubauer, Munchen (DE); Stefano Ambrosius Klinke, Kerpen (DE); Frank Lorenz, Bocholt (DE)

Correspondence Address: BELL, BOYD & LLOYD, LLC, P. O. BOX 1135, CHICAGO, IL, 60690-1135, US

(21) Appl. No.: 10/477,381

(22) PCT Filed: May 11, 2001
(86) PCT No.: PCT/DE01/01826

(51) Int. Cl. G10L 11/04

(52) U.S. Cl. 704/206; 704/207

(57) ABSTRACT

A method is provided for expanding the bandwidth of a narrow band filtered speech signal, particularly a speech signal transmitted by a telecommunications device, in a simple and cross-effective manner without losses in quality, wherein the narrow band filtered speech signal is estimated in relation to frequency components above a cut-off frequency via independent methods either in the time domain or in the frequency domain and expanded on the basis of the respective estimation.

Method for expanding the bandwidth of a narrowband filtered speech signal, in particular a speech signal transmitted by a telecommunications device

The present invention relates to a method for expanding the bandwidth of a narrowband filtered speech signal, in particular a speech signal transmitted by a telecommunications device, according to the preamble of claim 1, the preamble of claim 4, the preamble of claim 7, the preamble of claim 17 and the preamble of claim 23.

Speech coding methods are characterized by their different bandwidths. Thus, for example, there are narrowband coders, which convert speech signals lying in the frequency range up to 4000 Hz into coded speech signals, and wideband coders, which convert speech signals typically ranging between 50 and 7000 Hz into coded speech signals. In the process the speech signals supplied to the narrowband coder are usually sampled at a lower sampling rate than the speech signals supplied to the wideband coder. For that reason the net bit rate of the narrowband coder is usually lower than the net bit rate of the wideband coder.

If the coded speech signals of different bandwidth are transmitted within the same channel mode, this allows the use of different rates for the channel coding, which leads to different forms of error protection. Thus, if the same channel mode is used, it is possible in the event of poor transmission conditions over the transmission channel to add more redundant error protection bits to the narrowband coded speech signals in the course of the channel coding than to the wideband coded speech signals. Accordingly, with varying transmission conditions there is the possibility of transmitting speech signals over a transmission channel whereby, depending on the transmission conditions, the speech coding is switched between wideband and narrowband speech coding [“wideband” to narrowband” switching (“WB/NB” switching)] and the channel coding, in particular the rate of the channel coding, is adapted to it. On the receiver side, the coded speech signals are decoded using a method adapted to the coding method.

The new telecommunications system for wireless telecommunication UMTS (Universal Mobile Telecommunications System), for example, has been standardized on a wideband coding method in order to ensure very good speech quality with the future UMTS terminal devices. A disadvantage with an approach of this kind is that a receiving subscriber experiences the sudden switch from wideband coding to narrowband coding in particular and the attendant loss of quality as extremely annoying.

This so-called “WB/NB switching” problem can also occur during the handover situation in telecommunications systems for wireless telecommunication having a plurality of base stations and mobile units, where the base stations are assigned to different telecommunications subsystems and the mobile units within the system are configured as dual-mode mobile units for cross-subsystem roaming: The starting point for the considerations is an existing wideband call connection between a base station and a mobile unit. If a handover to another base station is now performed for the mobile unit or the call subscriber, it can happen that the base station taking over the call belongs to a subsystem which does not support the wideband speech service. For this reason a switch is made back to narrowband coding and decoding.

In this scenario too, the receiving subscriber will experience the sudden switchover from wideband coding to narrowband coding in particular and the attendant loss of quality as extremely annoying.

Base stations which, as described above, do not support wideband call connections, as well as other telecommunications terminal devices which allow only narrowband coding or analog speech signal transmission in the range from typically 300 to 3400 Hz, are still very widely used, since the telecommunications systems known to date have hitherto generally transmitted speech signals at a bandwidth of approximately 3.1 kHz between 3400 Hz (first cut-off frequency) and 300 Hz (second cut-off frequency), since the intelligibility of the communication is adequate in spite of the consequent band limitation of the speech. In the process the telecommunications systems known hitherto use different digital and analog coding methods to transmit the speech signals.

In order to achieve a quality improvement such that a speech quality in telecommunications systems is comparable with the speech quality of radio and television signals, it becomes necessary on the receiver side to estimate and synthesize frequency components of the speech which lie outside the bandwidth from 300 Hz to 3400 Hz.

Various methods are known in the prior art which allow an expansion of the bandwidth of a narrowband speech signal.

For example, for an expansion of the bandwidth in the lower frequency range (<300 Hz), EP 0 994 464 discloses a method of reconstructing signal components of the lower frequency range of a speech signal limited toward low frequencies by means of a high-pass function, wherein the high-pass filtering described is performed e.g. during the speech transmission via a telephone at the remote subscriber end (transmission characteristic of the telephone).

Here, the signal components are reconstructed by generating frequencies of the lower frequency range using a non-linear signal processing technique by means of which sub-harmonic frequencies of the signal are generated and added to the high-pass signal.

Furthermore, EP 0 994 464 also discloses a development thereof in which the non-linear signal processing is performed by multiplication of the signal by a function of the signal.

A disadvantage of the methods cited is that as a rule the filter characteristic (transmission characteristic of the telephone) by means of which the signal has been filtered at the remote subscriber terminal device is not known and may be very different for different device types. This is shown in FIG. 8. A reconstruction of the speech signal is therefore only possible if the filter characteristics of the participating subscriber devices are known in each case or if these devices are designed to be compatible with one another.

In many methods of digital speech coding, the digital speech signal is split for further processing and transmission into coefficients which describe the spectral coarse structure of a signal segment and into an excitation or prediction error signal, referred to as the residual signal, which forms the spectral fine structure. This residual signal no longer contains the spectral envelope of the speech signal which is represented by the coefficients which describe the spectral coarse structure.

On the decoder side, these two parts—mostly transmitted in quantized form—which describe the spectral coarse and fine structure are joined together again and form the decoded speech signal.

A typical representation for the spectral coarse structure is formed by the LPC (Linear Predictive Coding) coefficients which are determined during the linear prediction analysis and which describe a recursive filter, referred to as the synthesis filter, whose transmission function corresponds to the spectral coarse structure. These coefficients are used in their actual or a transformed form in many speech coders. On the receiver side the received residual signal is used in this case as an input signal for the synthesis filter, with the result that the reconstructed speech signal is available at the output of the filter. Consequently the LPC coefficients are a representation of the spectral coarse structure of a speech signal segment and can be used for the synthesis of speech signals using a suitable excitation signal.

In order to expand the bandwidth in the upper frequency range, methods are known which are based on special speech data books, referred to as codebooks, which form a relation between the LPC coefficients of a narrowband speech signal segment and those of a wideband speech signal segment. As a result the codebooks have to be trained simultaneously with both narrowband and wideband speech and stored in the communications terminal device.

Also, a wideband excitation signal containing frequency components above the bandwidth of the narrowband speech signal is generated from the narrowband residual signal which was generated by the linear prediction analysis of the narrowband speech signal.

Since the codebooks have to be stored in the telecommunications device, in addition to the laborious and time-consuming training of the codebooks with both narrowband and wideband speech, the high memory space requirement and the difficulty of a unique, speaker- and speech-independent correlation between the two codebooks are also disadvantageous.

In order to reduce the memory space requirement for the use of codebooks, a method developed by the Technische Hochschule Aachen is known according to which only one codebook is now used in conjunction with a hidden Markov model by means of which the statistical speech characteristics can be described.

In practice these methods for expanding the bandwidth in the upper frequency range have not found any use, as the quality of the generated wideband speech signals is also unsatisfactory and dependent on the respective speech signal.

The object of the invention is to expand the bandwidth of a narrowband filtered speech signal in a simple and cost-effective manner without losses in quality.

This object is achieved based on the method defined in the preamble of claim 1 by means of the features recited in the characterizing part of claim 1, based on the method defined in the preamble 5 of claim 4 by means of the features recited in the characterizing part of claim 4, based on the method defined in the preamble of claim 7 by means of the features recited in the characterizing part of claim 7, based on the method defined in the preamble of claim 17 by means of the features recited in the characterizing part of claim 17, and based on the method defined in the preamble of claim 23 by means of the features recited in the characterizing part of claim 23.

With the inventive method according to claim 1, the narrowband filtered speech signal is estimated in relation to frequency components above a first cut-off frequency and below a second cut-off frequency separately from each other—in the sense of: by independent different methods—and expanded on the basis of this respective estimation. The estimation can preferably be carried out either in the time domain (claim 2) or in the frequency domain (claim 3).

Two methods by means of which the narrowband filtered speech signal can be estimated in relation to frequency components above the first cut-off frequency in the frequency domain are specified in claims 4 and 5 and in claims 7 and 8, whereby initially the narrowband speech signal is in each case subdivided into speech signal time segments having a spectral structure, each narrowband speech signal time segment is classified as a voiced or an unvoiced sound, enhancements are generated having a spectral structure and serving to expand the narrowband speech signal in relation to the sound-related classification performed, whereby at least for the case of the voiced sound the enhancement is independent of the respective sound, the spectral structure of the narrowband speech signal time segment, which according to claim 6 is preferably computed by means of an FFT (Fast Fourier Transform) analysis, and the spectral structure of the generated enhancement are combined in time segment sequence in such a way that an expanded spectral structure is produced in each case, and subsequently according to claim 4, a wideband expanded speech signal time segment is generated in each case from the expanded spectral structure, in particular by means of an IFFT (Inverse Fast Fourier Transform) analysis according to claim 6, or according to claim 7, with regard to the time segment duration, prediction error signal time segments of a wideband prediction error signal corresponding to the narrowband speech signal time segments are generated and in each case a wideband expanded speech signal time segment is generated from the expanded spectral structure and the respective wideband prediction error signal time segment, before finally a wideband expanded speech signal is generated from the individual wideband expanded speech signal time segments.

An alternative method by means of which the narrowband filtered speech signal can be estimated in relation to frequency components above the first cut-off frequency in the time domain is specified in claims 17 and 18, whereby initially the narrowband speech signal is subdivided into speech signal time segments and each narrowband speech signal time segment is classified as a voiced sound or an unvoiced sound and subsequently the narrowband speech signal time segments are processed non-linearly in such a way that in each case a modified speech signal time segment is generated which on the one hand contains the respective essentially unmodified narrowband speech signal time segment and on the other hand contains signal components generated by the non-linear signal processing above the first cut-off frequency and the modified speech signal time segments are filtered differently in relation to the sound-related classification performed in such a way that wideband expanded speech signal time segments and hence a wideband expanded speech signal are produced from the modified speech signal time segments.

Estimating the frequency components above the first cut-off frequency of the narrowband filtered speech signal in the time domain is of advantage, because no assessment of the spectrum and consequently no compute-intensive transformation into the spectral domain is necessary. Furthermore, the modified speech signal time segments are filtered in such a way that in the case of a voiced speech signal time segment little energy is allowed through above the first cut-off frequency—e.g. 4 kHz—and in the case of an unvoiced speech signal time segment more energy is allowed through above the first cut-off frequency—e.g. 4 kHz.

A significant advantage of the presented methods according to the invention for expanding a narrowband filtered speech signal in the upper frequency range according to claims 4, 5, 7, 8, 17 and 18 compared to the known methods lies in the saving of memory space, because memory space-intensive codebooks can essentially be dispensed with. Furthermore, they permit the expansion of the narrowband speech signal without precise knowledge of the original wideband excitation signal. The methods according to claims 7 and 8 and 17 and 18 are further distinguished by very low computing overhead. Finally, with all the methods there is no need for the training of the memory space-intensive codebooks, said training usually having to be carried out in the development phase of telecommunications devices used for speech transmission.

In the development according to claim 9, the enhancement generated in each case for the narrowband speech signal time segments classified as voiced sounds is generated in such a way that the energy of this enhancement is negligible in relation to the total energy of the narrowband speech signal segment.

This enhancement can always be the same regardless of which voiced sound—e.g.: “a”, “e” or “i”—is concerned, so that there is no need to determine the sound or to employ a codebook for voiced sounds.

By means of the development according to claim 9, a quality improvement of the wideband expanded speech signal is ensured, since it is taken into account by this type of development that with unvoiced sounds in the upper frequency range there is a continuation of a significant part of the signal energy, thereby preventing the precise course of this part from being neglected due to the fact that it is always the same enhancement that is made and hence the synthesized speech signal would be corrupted.

In the development according to claim 10, the enhancement generated in each case for the narrowband speech signal segments classified as unvoiced sounds is generated in such a way that the energy of this enhancement is not negligible in relation to the total energy of the narrowband speech signal segment. In this way an expansion of the narrowband filtered speech signal can be performed easily without precise knowledge of the unvoiced sound.

In the development according to claim 11, the enhancement generated in each case for the narrowband speech signal time segments classified as unvoiced sounds is generated in such a way that, based on at least one wideband codebook, second filter coefficients of a wideband speech signal time segment are determined from first filter coefficients of the narrowband speech signal time segment. As a result the quality of the synthesized speech signal can be improved compared to the speech signal where no codebook is used.

The development according to claim 12 permits the reconstruction of a wideband speech signal expanded in the upper frequency range on the basis of determined wideband filter coefficients.

The development according to claim 13 permits the reconstruction of a wideband speech signal expanded in the upper frequency range on the basis of determined wideband filter coefficients and a wideband prediction error signal time segment.

In the methods according to claims 7 and 8, no codebooks are required for estimating the filter coefficients for the synthesis filter, as a result of which it is possible to reduce the memory space requirement in a beneficial manner. This notwithstanding, the estimation of the frequency envelope above the first cut-off frequency, e.g. 4 kHz, is very rough, which in the case of certain unvoiced sounds sometimes leads to undesirable artifacts being produced. In order to avoid this, in the development according to claim 14 the wideband filter coefficients are compared with the entries from a wideband codebook and the entry in the wideband codebook which best matches the wideband filter coefficients is taken as the basis for the filter coefficient of the synthesis of the wideband expanded speech signal. The advantage of this method is that by making use of a codebook the filter coefficients found on the basis of the preceding codebook comparison are a good approximation of the real coefficients both below the first cut-off frequency (e.g. 4 kHz) and above the first cut-off frequency (e.g. 4 kHz). This means that the estimation of the coefficients above the first cut-off frequency is no longer so rough. Furthermore it is advantageous that on the one hand only the wideband codebook is now required and the narrowband codebook is no longer required in addition, and on the other hand, as also in the case of the prior art (method developed at the TH Aachen), a hidden Markov model is no longer required.

In order to improve the quality of the wideband expanded speech signal according to claims 4 to 8, it is advantageous if according to claim 16 the wideband expanded speech signal time segment generated in each case from the expanded spectral structure is high-pass filtered, the high-pass filtered speech signal time segment is combined with the corresponding narrowband speech signal time segment, and the wideband expanded speech signal is generated from the individual combined speech signal time segments.

In the development according to claim 19, the signal components generated in each case by the non-linear signal processing for the narrowband speech signal time segments classified as voiced sounds are generated in such a way that the energy of the respective signal component is negligible in relation to the total energy of the narrowband speech signal time segment.

In the development according to claim 20, the signal components generated in each case by the non-linear signal processing for the narrowband speech signal time segments classified as unvoiced sounds are generated in such a way that the energy of the respective signal component is not negligible in relation to the total energy of the narrowband speech signal time segment.

According to claim 21 it is advantageous—because easy to implement—if the signal components are generated by spectral mirroring.

According to claim 22, the method for expanding the narrowband filtered speech signal can be advantageously—in the sense of a simplified computation and execution of the method—developed by selecting narrowband speech signal time segments of equal length.

A method whereby the narrowband filtered speech signal can be estimated in relation to frequency components below the second cutoff frequency is specified in claims 23 and 24, according to which first, a prediction error signal of the narrowband speech signal is computed and then the filter characteristic of the narrowband filtered speech signal is estimated with reference to the prediction error signal and on the basis of the filter characteristic a process for processing the narrowband speech signal is controlled in such a way that a wideband expanded speech signal is generated.

A significant advantage of the method according to claim 23 is the easily achievable expansion of a narrowband filtered speech signal in the lower frequency range without knowledge of the original wideband excitation signal and without knowledge of the transmission filter characteristic of the telecommunications terminal devices, which expansion achieves an improvement in the quality of the speech signal.

According to claim 25, the filter characteristic of the narrowband filtered speech signal is estimated by a comparison of the partial energies of the prediction error signal measured in at least two frequency ranges and from the resulting energy differences conclusions are drawn as to the filter characteristic of the narrowband filtered speech signal.

The development according to claims 26 and 27 permits, through adjusted equalization of the narrowband filtered speech signal, an improvement in the quality of the speech signal which can advantageously be used in cases where the amplification of the low frequencies is not high.

The development according to claim 26 achieves an adjustment based on simple evaluation of the inverse filter characteristic.

The alternative approach according to claim 27 similarly permits an adjusted equalization through reconstruction of base frequency and/or at least one harmonic and prevents an intermodulation.

The development according to claim 28 prevents undesirable harmonics being added to the original signal by removing the undesirable components of the expanded speech signal and is advantageously used when the expanded signal has DC components.

Further advantageous embodiments are specified in the remaining subclaims.

Further details, features and advantages of the invention are described in more detail below with reference to the exemplary embodiments presented in the Figures, in which:

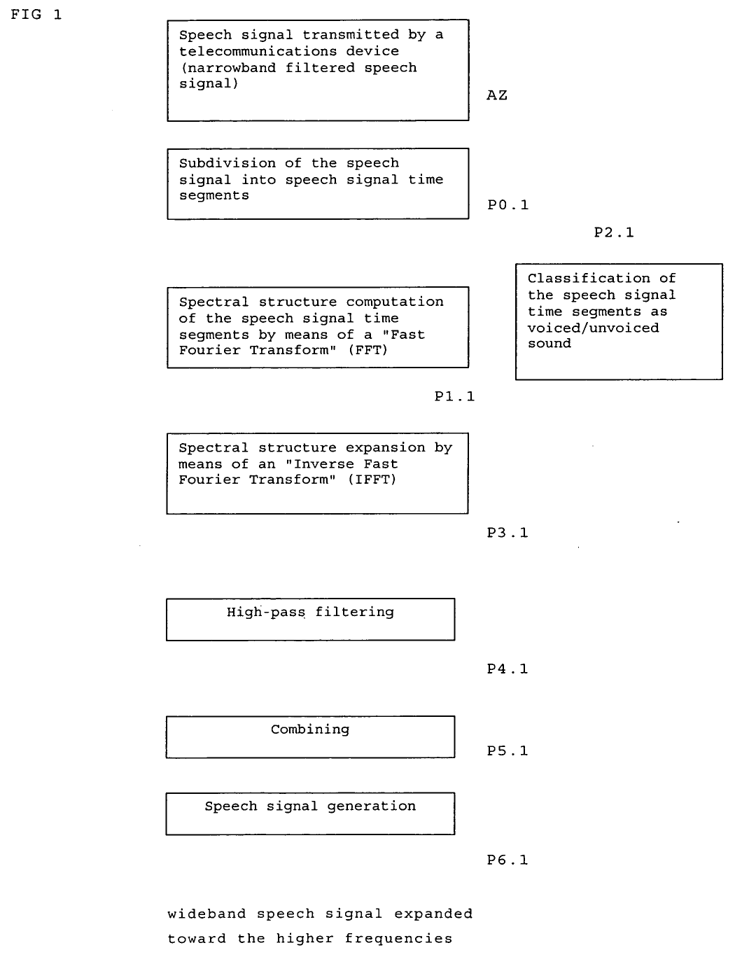

FIG. 1 shows as a first exemplary embodiment a flow diagram for expanding the bandwidth of a speech signal transmitted by a telecommunications device toward the higher frequencies above a first cut-off frequency of the narrowband filtered speech signal in the frequency domain,

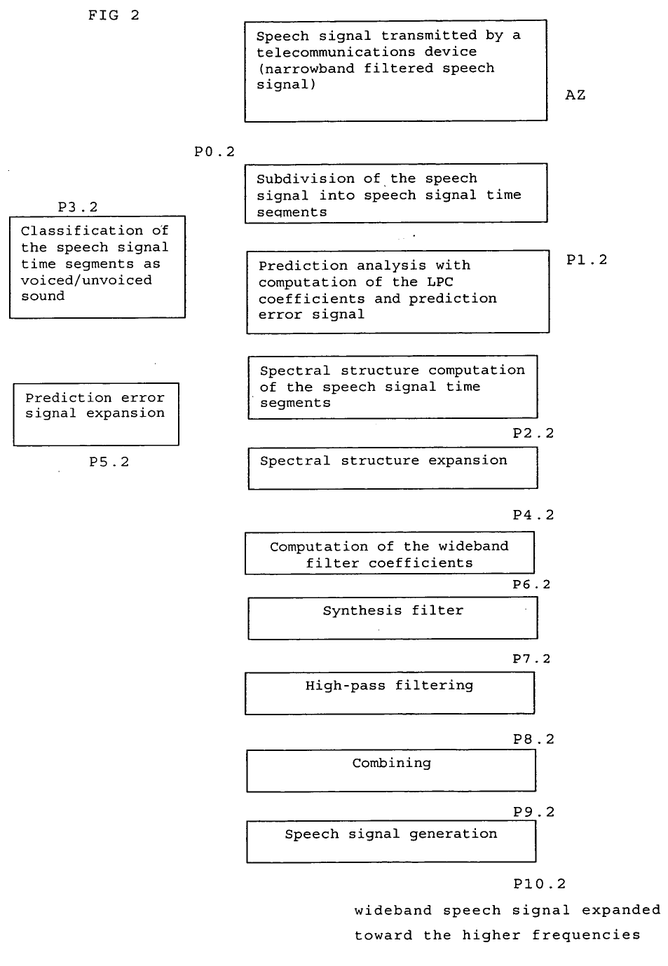

FIG. 2 shows as a second exemplary embodiment a flow diagram for expanding the bandwidth of a speech signal transmitted by a telecommunications device toward the higher frequencies above a first cut-off frequency of the narrowband filtered speech signal in the frequency domain,

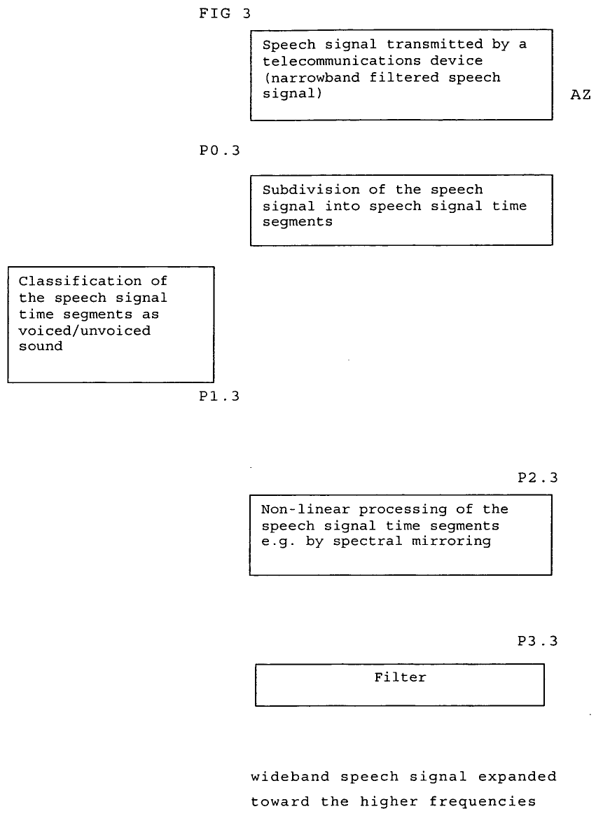

FIG. 3 shows as a third exemplary embodiment a flow diagram for expanding the bandwidth of a speech signal transmitted by a telecommunications device toward the higher frequencies above a first cut-off frequency of the narrowband filtered speech signal in the time domain,

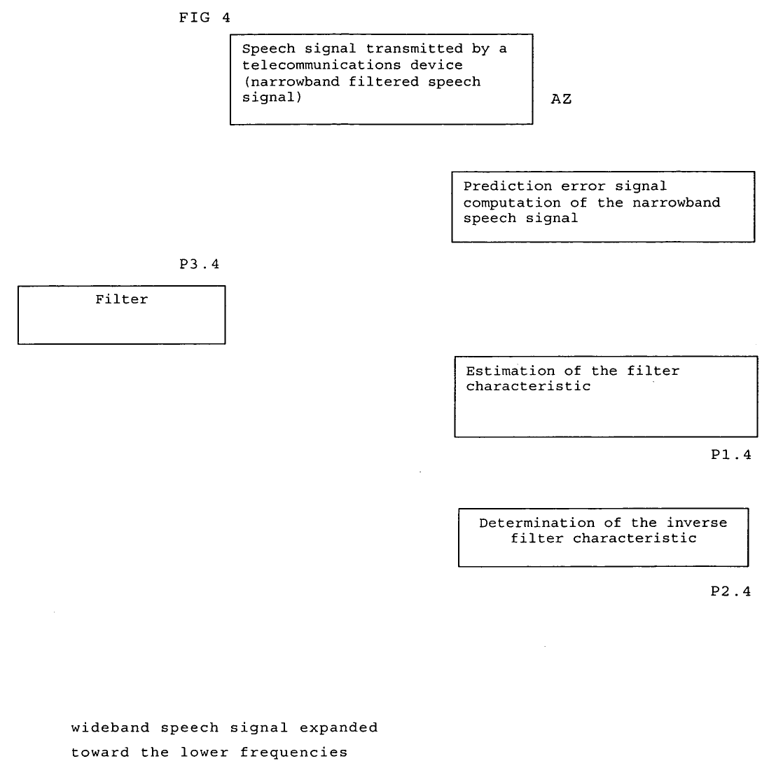

FIG. 4 shows as a fourth exemplary embodiment a flow diagram for expanding the bandwidth of a speech signal transmitted by a telecommunications device toward the lower frequencies below a second cut-off frequency of the narrowband filtered speech signal,

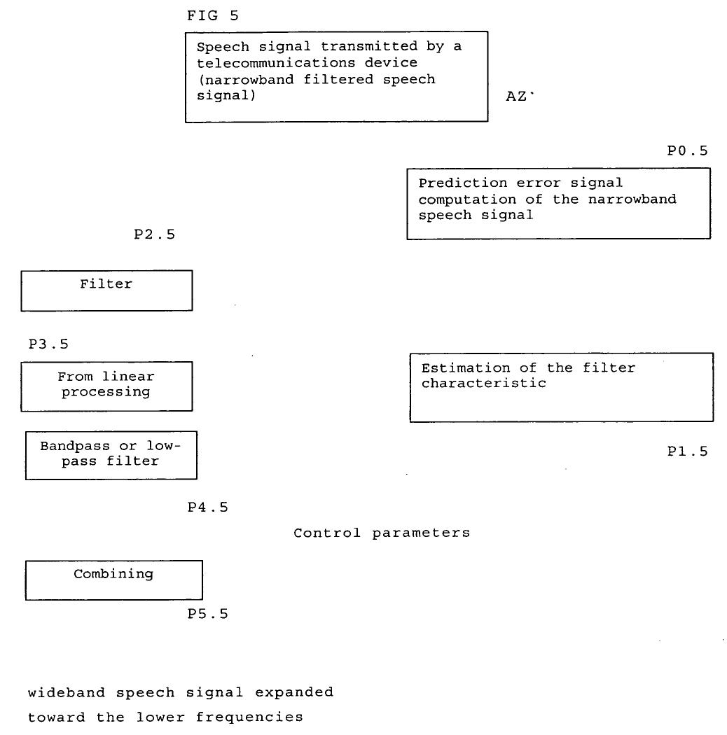

FIG. 5 shows as a fifth exemplary embodiment a flow diagram for expanding the bandwidth of a speech signal transmitted by a telecommunications device toward the lower frequencies below a second cut-off frequency of the narrowband filtered speech signal,

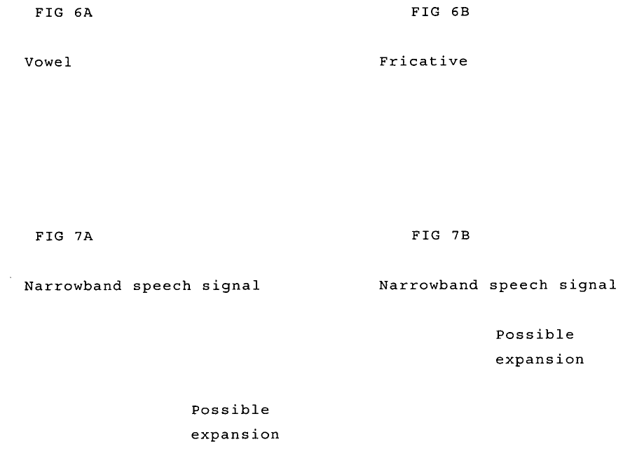

FIG. 6a shows the spectrum of a voiced sound (vowel),

FIG. 6b shows the spectrum of an unvoiced sound (fricative),

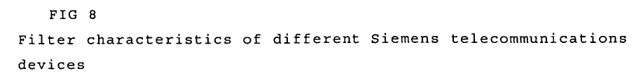

FIG. 7a shows a possible expansion of the spectrum of a vowel,

FIG. 7b shows a possible expansion of the spectrum of a fricative,

FIG. 8 shows the filter characteristics of different device types,

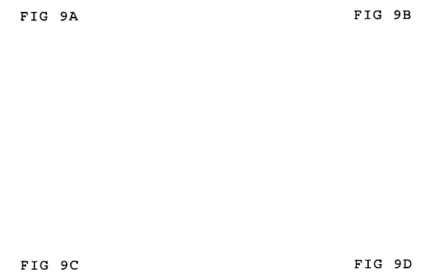

FIG. 9a shows the shape of a first speech signal,

FIG. 9b shows the shape of a first residual signal resulting from the speech signal,

FIG. 9c shows a short-time spectral analysis of the speech signal,

FIG. 9d shows a short-time spectral analysis of the residual signal.

FIG. 1 shows with the aid of a flow diagram a first process (a first method) for expanding the bandwidth of a speech signal transmitted by a telecommunications device toward the higher frequencies above a first cut-off frequency—e.g. 4 kHz—of the narrowband filtered speech signal in the frequency domain. The speech signal is transmitted by the telecommunications device according to an initial status AZ of the process shown. There is therefore a narrowband filtered speech signal present.

In a first process step P0.1, this speech signal is subdivided into narrowband speech signal time segments of preferably equal size. Next, in a second process step P1.1, the spectral structure is computed for each speech signal time segment by means of a “Fast Fourier Transform” (FFT) and in a third process step P2.1 a classification is performed in such a way that the respective speech signal time segment is classified or defined as a voiced sound—such as, for example, “a”, “e” or “i”, whose articulation has a spectrum as shown in FIG. 6a—or as an unvoiced sound—such as, for example, “s”, “sch” or “f”, whose articulation has a spectrum as shown in FIG. 6b.

This discrimination will take place for example on the basis of the position of the first formant or on the basis of the ratio of spectral components above and below a certain frequency—2 kHz for example. A discrimination on the basis of the narrowband spectrum is easy to perform, since, as a comparison of the spectrum of a voiced sound shown in FIG. 6a with the spectrum of an unvoiced sound shown in FIG. 6b reveals, voiced and unvoiced sounds usually have very different spectra.

Alternatively, a short-time signal energy of a first narrowband filtered speech signal time segment is determined together with a long-time signal energy on the basis of further succeeding narrowband filtered speech signal time segments correlating with the first signal and then the detection is realized by comparison of a ratio of short-time signal energy to long-time signal energy with a threshold value.

Alternatively, the discrimination can be performed by comparison of the short-time signal energy—i.e. the signal energy in a short time section of the narrowband speech signal—and the long-time signal energy—i.e. the signal energy considered over a relatively long time section—and subsequent comparison of the short-time to long-time energy ratio with a fixed threshold value.

Following this, in a fourth process step P3.1 in relation to the sound-related classification performed in the third process step P2.1, the spectral structure computed in the second process step P1.1 is expanded by means of an “Inverse Fast Fourier Transform” (IFFT). This happens in such a way that, in time segment sequence in relation to the sound-related classification performed in the third process step P2.1, enhancements to expand the speech signal are generated, said enhancements in each case having a spectral structure, whereby for example (in particular) for the case of the voiced sound the enhancement is independent of the respective sound (with identification of the type of speech sound—voiced/unvoiced—the enhancement necessary for expanding the bandwidth is also determined), the spectral structure of the narrowband speech signal time segment and the spectral structure of the generated enhancement are combined in time segment sequence to form an expanded spectral structure and a wideband expanded speech signal time segment is generated out of this expanded spectral structure.

Following on from this, there are two possibilities of obtaining the wideband speech signal expanded toward the higher frequencies.

In order to achieve a certain improvement in the quality of the wideband expanded speech signal it is possible to filter the respective wideband expanded speech signal time segment generated in the fourth process step P3.1 in a fifth process step P4.1 by means of a high-pass filter, then to combine this filtered speech signal time segment with the corresponding narrowband speech signal time segment from the first process step P0.1 in a sixth process step P5.1, before finally, in a seventh process step P6.1, the wideband speech signal expanded toward the higher frequencies is generated from the individual combined speech signal time segments by joining these time segments together.

If such an improvement in the quality of a wideband expanded speech signal can be left aside, it is also possible as an alternative to generate the wideband speech signal expanded toward the higher frequencies immediately after the fourth process step P3.1 from the wideband expanded speech signal time segments generated in this process step in each case in the seventh process step P6.1 by joining these time segments together.

First, the inventive expansion of a narrowband filtered speech signal toward the higher frequencies according to a second process (a second method) shall be explained with reference to FIG. 2.

Generally, a speech signal is analyzed by linear prediction. In this case, on the assumption that a speech sampling value can be approximated by the linear combination of previous speech sampling values, linear prediction coefficients, referred to as LPC coefficients, which represent the filter coefficients of a speech synthesis filter are computed together with an excitation signal for this synthesis filter.

Applying the LPC coefficients belonging to a speech signal segment to this speech signal segment by filtering the segment using a non-recursive digital filter defined by these coefficients produces the so-called prediction error signal. This signal describes the difference between the signal value estimated by the linear prediction and the actual signal value. At the same time it also represents the excitation signal for the purely recursive synthesis filter defined by the LPC coefficients, by means of which the original speech signal segment is reconstituted by filtering the prediction error or excitation signal.

Knowledge of a wideband excitation signal and the filter coefficients that describe the (wideband) speech signal in terms of the linear prediction is required in order to expand a speech signal toward the higher frequencies.

As the speech signal is present as a narrowband signal in, for example, telecommunications systems using narrowband transmission, a wideband excitation signal is determined according to the invention on the basis of the narrowband excitation signal computed from the speech signal by means of linear prediction.

This is achieved for example by frequency mirroring of the narrowband excitation signal, whereby the frequency components between 0 kHz and 4 kHz are mirrored at the 4 kHz spectral line into a range from 4 kHz to 8 kHz.

Alternatively, the computation can also be implemented by addition of the narrowband signal with Gaussian (white) or limited (colored) noise.

FIG. 2 shows with the aid of a flow diagram the second process (the first method) for expanding the bandwidth of a speech signal transmitted by a telecommunications device toward the higher frequencies above a first cut-off frequency—e.g. 4 kHz—of the narrowband filtered speech signal in the frequency domain. The speech signal is again transmitted by the telecommunications device according to an initial status AZ of the process shown. Thus, there is again a narrowband filtered speech signal present.

In a first process step P0.2, this speech signal is subdivided into narrowband speech signal time segments of preferably equal size. Next, in a second process step P1.2, LPC coefficients and a narrowband prediction error signal are computed for each speech signal time segment in known fashion as part of a prediction analysis, in a third process step P2.2 the spectral structure of the speech signal time segments is computed on the basis of the LPC coefficients and the narrowband prediction error signal, and in a fourth process step P3.2 a classification is performed in such a way that the respective speech signal time segment is classified or defined as a voiced sound—such as, for example, “a”, “e” or “i”, whose articulation has a spectrum as shown in FIG. 6a—or as an unvoiced sound—such as, for example, “s”, “sch” or “f”, whose articulation has a spectrum as shown in FIG. 6b.

This discrimination will take place for example on the basis of the position of the first formant or on the basis of the ratio of spectral components above and below a certain frequency −2 kHz for example. A discrimination on the basis of the narrowband spectrum is easy to perform, since, as a comparison of the spectrum of a voiced sound shown in FIG. 6a with the spectrum of an unvoiced sound shown in FIG. 6b reveals, voiced and unvoiced sounds usually have very different spectra.

Alternatively, a short-time signal energy of a first narrowband filtered speech signal time segment is determined together with a long-time signal energy on the basis of further succeeding narrowband filtered speech signal time segments correlating with the first signal and then the detection is realized by comparison of a ratio of short-time signal energy to long-time signal energy with a threshold value.

Alternatively, the discrimination can be performed by comparison of the short-time signal energy—i.e. the signal energy in a short time section of the narrowband speech signal—and the long-time signal energy—i.e. the signal energy considered over a relatively long time section—and subsequent comparison of the short-time to long-time energy ratio with a fixed threshold value.

Following this, in a fifth process step P4.2 in relation to the sound-related classification performed in the third process step P2.1, the spectral structure computed in the third process step P2.2 is expanded. This happens in such a way that, in time segment sequence in relation to the sound-related classification performed in the fourth process step P3.2, enhancements to expand the speech signal are generated, said enhancements in each case having a spectral structure, whereby for the case of the voiced sound the enhancement is independent of the respective sound (with identification of the type of speech sound—voiced/unvoiced—the enhancement necessary for expanding the bandwidth is also determined), the spectral structure of the narrowband speech signal time segment and the spectral structure of the generated enhancement are combined in time segment sequence to form an expanded spectral structure.

If the narrowband speech signal investigated in the fifth process step P4.2 is a voiced sound, then the narrowband spectral structure, as shown in FIG. 7a, is expanded by means of an enhancement in such a way that the expanded wideband spectral structure above 4 kHz possesses considerably less energy than below 4 kHz. A drop, an exponential drop, a rise, a constant zero level or a constant level of the spectral structure toward higher frequencies are possible for example.

Alternatively, it is also possible to dispense entirely with an enhancement, because as a rule the signal energy of a voiced sound above the cut-off frequency of the narrowband speech signal (e.g. 4 kHz) is negligible (cf. FIG. 6a). For this case the generated wideband frequency response corresponds to the narrowband frequency response of the underlying narrowband speech signal.

It is also possible that the expansion that is performed after detection of a voiced sound is always the same irrespective of the precise knowledge of the sounds (adjusted solely to the energy of the narrowband speech signal), with the result that a simple, cost-effective and quick implementation of this expansion is achieved.

If the narrowband speech signal investigated in the fifth process step P4.2 is an unvoiced sound, then the narrowband frequency response, as shown in FIG. 7b, is expanded in such a way that—in contrast to the expansion for voiced sounds—it possesses a not negligible part of its total energy in the range above the first cut-off frequency of the narrowband speech signal (e.g. 4 kHz).

In this case too, the expansion can always be realized by a similar spectral expansion (adjusted solely to the energy of the narrowband speech signal) irrespective of the precise knowledge of the sounds, with the result that by this means a simple, cost-effective and quick implementation of this expansion is likewise achieved.

As the result of the first to fifth process steps P0.2 . . . P4.2 in FIG. 2, a new expanded wideband spectral structure is therefore generated as a function of the sound on which the existing narrowband spectral structure is based.

As an alternative approach to performing the expansion in the fifth process step P4.2, recourse can also be made to codebooks. A requirement for this is that there is present at least one codebook which represents the relationship, for example with the aid of the statistical characteristics of the speech which can be stored e.g. in a hidden Markov model (HMM), between narrowband and wideband filter coefficients and yields wideband filter coefficients on the basis of the statistical relationship with the narrowband filter coefficients computed in the second process step P1.2.

In an alternative assignment of narrowband to wideband filter coefficients which is reflected by one or more codebooks, associated wideband filter coefficients are determined from the narrowband filter coefficients computed in the second process step P1.2. These filter coefficients are then used for the synthesis of frequency components above the cut-off frequency of the narrowband speech signal (e.g. 4 kHz).

The codebooks are, however, only required if the investigation of the narrowband spectral envelope determined in the fourth process step P3.2 detects an unvoiced sound. Therefore they can also be limited to filter coefficients for unvoiced sounds and hence be very small, as a result of which they do not represent any great memory space requirement for a telecommunications terminal device.

In addition, in a sixth process step P5.2, the narrowband prediction error signal computed in the second process step P1.2 is expanded into a wideband prediction error signal, so that with regard to the time segment duration, prediction error signal segments of the wideband prediction error signal corresponding to the narrowband speech signal time segments are generated.

Following this, from the expanded spectral structure generated in the fifth process step P4.2 by computation of wideband filter coefficients in a seventh process step P6.2 and the wideband prediction error signal segment generated in each case in the sixth process step P5.2, a wideband expanded speech signal time segment is generated in each case in an eighth process step P7.2 by means of a so-called synthesis filter.

Following on from this, there are two possibilities of obtaining the wideband speech signal expanded toward the higher frequencies.

In order to achieve a certain improvement in the quality of the wideband expanded speech signal it is possible to filter the respective wideband expanded speech signal time segment generated in the eighth process step P7.2 in a ninth process step P8.2 by means of a high-pass filter, then, in a tenth process step P9.2, to combine this filtered speech signal time segment with the corresponding narrowband speech signal time segment from the first process step P0.2 before finally, in an eleventh process step P10.2, the wideband speech signal expanded toward the higher frequencies is generated from the individual combined speech signal time segments by joining these time segments together.

If such an improvement in the quality of a wideband expanded speech signal can be left aside, it is also possible as an alternative to generate the wideband speech signal expanded toward the higher frequencies immediately after the eighth process step P7.2 from the wideband expanded speech signal time segments generated in this process step in each case in the eleventh process step P10.2 by joining these time segments together.

The wideband filter coefficients describe the spectral structure of a wideband speech signal on account of the fact that they were computed from the estimation of the wideband spectral structure.

These wideband filter coefficients are then available for the speech synthesis by means of which, using the—as already described—generated wideband excitation signal or prediction signal, the wideband speech signal time segments and hence the wideband expanded speech signal are generated, the quality of this wideband expanded speech signal being considerably better than that of the narrowband filtered speech signal.

The wideband filter coefficients computed on the basis of the codebooks and supplied to the synthesis filter are used for synthesis of the upper frequency band of the speech signal, which leads to an improvement in the quality of the speech signal due to the bandwidth expansion.

According to the invention, wideband filter coefficients can therefore be determined without the aid of codebooks or with very small codebooks, a possible application of the inventive method for expanding the speech signal bandwidth in the upper frequency range in telecommunications systems existing in which use is made of speech coders with variable bit rate which have both wideband and narrowband coding capability, since there the case can occur that the speech coder switches between narrowband and wideband in the course of the communication.

In the process the considerable deterioration in communication quality caused by this is prevented by the use in communications terminal devices of the method described in this invention.

In telecommunications systems which operate, for example, according to the UMTS standard, and in which the above-described problems occur, an estimation according to the invention of the wideband speech signal components during the narrowband transmission can therefore be used advantageously in order to ensure a constant quality.

FIG. 3 shows with the aid of a flow diagram a third process (a third method) for expanding the bandwidth of a speech signal transmitted by a telecommunications device toward the higher frequencies above a first cut-off frequency—e.g. 4 kHz—of the narrowband filtered speech signal in the time domain. The speech signal is again transmitted by the telecommunications device according to the initial status AZ of the process shown. Thus, there is again a narrowband filtered speech signal present.

In a first process step P0.3, this speech signal is subdivided into narrowband speech signal time segments of preferably equal size. Next, in a second process step P1.3, a classification is performed in such a way that the respective speech signal time segment is classified or defined as a voiced sound—such as, for example, “a”, “e” or “i”, whose articulation has a spectrum as shown in FIG. 6a—or as an unvoiced sound—such as, for example, “s”, “sch” or “f” whose articulation has a spectrum as shown in FIG. 6b.

This discrimination will take place for example on the basis of the position of the first formant or on the basis of the ratio of spectral components above and below a certain frequency—2 kHz for example. A discrimination on the basis of the narrowband spectrum is easy to perform, since, as a comparison of the spectrum of a voiced sound shown in FIG. 6a with the spectrum of an unvoiced sound shown in FIG. 6b reveals, voiced and unvoiced sounds usually have very different spectra.

Alternatively, a short-time signal energy of a first narrowband filtered speech signal time segment is determined together with a long-time signal energy on the basis of further succeeding narrowband filtered speech signal time segments correlating with the first signal and then the detection is realized by comparison of a ratio of short-time signal energy to long-time signal energy with a threshold value.

Alternatively, the discrimination can be performed by comparison of the short-time signal energy—i.e. the signal energy in a short time section of the narrowband speech signal—and the long-time signal energy—i.e. the signal energy considered over a relatively long time section—and subsequent comparison of the short-time to long-time energy ratio with a fixed threshold value.

In addition, in a third process step P2.3, the narrowband speech signal time segments are processed non-linearly, preferably by spectral mirroring, in such a way that in each case a modified speech signal time segment is generated which on the one hand contains the respective essentially unmodified narrowband speech signal time segment and on the other hand contains signal components generated by the non-linear signal processing above the first cutoff frequency.

Next, in a fourth process step P3.3, the modified speech signal time segments are filtered differently in relation to the sound-related classification performed, in such a way that wideband expanded speech signal time segments and hence a wideband expanded speech signal are produced from the modified speech signal time segments, whereby in the case of a voiced speech signal time segments little energy is allowed through above the first cut-off frequency—e.g. 4 kHz—and in the case of an unvoiced speech signal time segment more energy is allowed through above the first cut-off frequency—e.g. 4 kHz.

Based on FIG. 8, the inventive expansion of a band-limited speech signal toward the lower frequencies and the reconstruction of the low frequency components shall initially be explained with reference to FIGS. 9a to 9d.

As discussed at the beginning, there is already known from EP 0 994 464 a method for spectral reconstruction of signal components of the lower frequency range of a speech signal limited toward low frequencies by means of a high-pass function, wherein the reconstruction is accomplished by generating frequencies of the lower frequency range by means of a non-linear signal processing technique, wherein for this purpose sub-harmonic frequencies of the signal are generated and added to the high-pass signal.

With existing methods for expanding the lower frequencies, in particular the method known from EP 0 994 464, it is necessary to know the filter characteristic used to filter a signal at a remote telecommunications terminal device. Generally, such methods can be optimally employed only using telecommunications equipment with the same characteristic, i.e. telecommunications terminal devices of the same type, since their filter characteristic is identical or has been adapted.

These methods cannot be employed in heterogeneous systems in which a multiplicity of different telecommunications devices as well as different types of telecommunications devices are used, since different types of telecommunications devices, e.g. Siemens telecommunications devices such as are shown in FIG. 8, have different filter characteristics.

The method according to the invention permits the expansion of band-limited speech signals in the lower frequency range in heterogeneous systems, since according to the invention filter characteristics are determined by means of an estimation, whereby, in order to estimate initially a speech signal as shown in FIG. 9a, a first residual signal, also referred to as a prediction error signal, as shown in FIG. 9b, is computed by means of the linear prediction method known from the literature, whereby the computation of the first residual signal can be omitted if it is already known by means of other processing steps.

Since, as is known from the specialist literature (Vary, Heute, Hess: “Digitale Sprachsignalverarbeitung” (“Digital speech signal processing”), Teubner Stuttgart 1998), the spectral shape of the first residual signal, particularly in comparison with the spectrum of the speech signal shown in FIG. 9c, as can be seen from FIG. 9d, is virtually flat in the transmitted frequency range and only falls away at the edges of the filter which band-limited the speech signal in the remote communications terminal device, this knowledge and the computed residual signal are used to estimate the filter characteristic, with a measurement of the residual signal energy in different frequency bands in particular yielding information about the filter characteristic.

FIG. 4 shows with the aid of a flow diagram a fourth process (a fourth method) for expanding the bandwidth of a speech signal transmitted by a telecommunications device toward the lower frequencies below a second cut-off frequency—e.g. 300 Hz—of the narrowband filtered speech signal. The speech signal is again transmitted by the telecommunications device according to an initial status AZ of the process shown. There is therefore a narrowband filtered speech signal present.

Starting with a narrowband filtered speech signal, the associated prediction error signal or residual signal is computed in a first process step P0.4, so that in a second process step P1.4 the filter characteristic is estimated and in a third process step P2.4 an inverse filter characteristic is computed on the basis of the estimated filter characteristic.

By means of the inverse filter characteristic, an inverse filter is then computed in a fourth process step P3.4, which filter is used to equalize the underlying narrowband speech signal and raise the low frequencies, it being necessary for this that not too large a value is chosen for the requisite amplification of the low frequencies, as otherwise the ratio of signal to interference level, generally referred to a signal-to-noise ratio, is considerably worsened.

Assuming this condition is observed, the wideband speech signal expanded toward the lower frequencies is present following completion of the equalization, with the result that an improvement in the quality of speech in a telecommunications terminal device is achieved when this method is achieved.

The equalization in this case refers to the filtering of the narrowband speech signal using the estimated inverse filter characteristic, i.e. low frequencies are amplified and the amplification is determined on the basis of the inverse filter characteristic.

Furthermore the method described in EP 0 994 464 can be improved in that the non-linear signal processing, in which the sub-harmonic frequencies of the speech signal are generated, is replaced by an absolute value generation of the signal (full-wave rectification) or by a half-wave rectification of the signal, which is easier to implement than the already known multiplication of the narrowband speech signal by a function of this signal, which approach avoids the relatively high signal processing overhead that results from the non-linear signal processing technique described in EP 0 994 464.

FIG. 5 shows with the aid of a flow diagram a fifth process (a fifth method) for expanding the bandwidth of a speech signal transmitted by a telecommunications device toward the lower frequencies below a second cut-off frequency—e.g. 300 Hz—of the narrowband filtered speech signal. The speech signal is again transmitted by the telecommunications device according to an initial status AZ of the process shown. There is therefore a narrowband filtered speech signal present.

Starting with a narrowband filtered speech signal, the associated prediction error signal or residual signal is computed in a first process step P0.5, so that in a second process step P1.5 the filter characteristic is estimated and at least one control parameter is determined.

The determined control parameter is used to control a non-linear signal processing process. For the non-linear signal processing, the narrowband filtered speech signal is filtered in a third process step P2.5 or taken directly as a basis, without additional filtering of the non-linear processing. The non-linear signal processing takes place in fourth process step P3.5. As a result of the determined control parameter, the non-linear signal processing is optimized in such a way that an amplitude of the basic frequency and/or missing harmonics, the reconstruction of which is intended to be achieved by the non-linear signal processing, is adjusted as a function of the underlying speech signal.

The filtering in the third process step P2.5 is performed only if the bandwidth of the underlying narrowband filtered speech signal is so large that there is a risk of an intermodulation.

Intermodulation in this context means that as a result of the non-linear signal processing, other—undesirable—frequencies that do not belong to the original signal can be generated between the harmonics.

In a fifth process step P4.5 the result of the non-linear signal processing is subjected to bandpass filtering in order to reduce undesirable signal components that lie outside the frequency range being synthesized.

As an alternative to bandpass filtering, low-pass filtering can also be performed. Low-pass filtering is generally used when the DC component always present in the signal to be filtered is small.

Finally, in a sixth process step P5.5, the signal filtered in this way is combined with the underlying speech signal preferably by addition, such that the wideband speech signal expanded toward the lower frequencies is present as the result.

A combination (not shown) of the methods shown in FIG. 4 and FIG. 5, i.e. a combination of non-linear signal processing and equalization of the narrowband speech signal is equally conceivable provided that the condition referred to in the exemplary embodiment according to FIG. 4, i.e. that the requisite amplification is not too great, is met.

In this case the two methods are combined in such a way that first the narrowband signal is equalized using the computed inverse filter and then the non-linear signal processing is applied.

Furthermore, a combination (also not shown) of the inventive method for expanding narrowband speech signals in the upper frequency range with the method for expanding narrowband speech signals in the lower frequency range, which can be referred to as a “wideband speech extender”, is particularly advantageous, since it ensures the synthesis of a wideband speech signal which comes closest to the underlying speech signal, with the result that a user of a telecommunications terminal device which utilizes the “wideband speech extender” hears a high-quality speech signal comparable with the quality of speech signals in radio and television sets.

This means that the “wideband speech extender” can be used in telecommunications devices in which a band-limited transmission of speech signals takes place with the object of creating the impression in the user of a wideband transmission.

In addition to the inventive method for expanding a narrowband speech signal in the upper frequency range, the “wideband speech extender” can also be used in telecommunications systems in which the “WB/NB switching” problem occurs, such that a wideband speech signal and hence a largely constant quality is guaranteed.

1. Method for expanding the bandwidth of a narrowband filtered speech signal, in particular a speech signal transmitted by a telecommunications device, above a cut-off frequency of the narrowband speech signal, characterized in that the narrowband speech signal is estimated in relation to frequency components above a first cut-off frequency and below a second cutoff frequency separately from each other and expanded on the basis of this respective estimation.

2. Method according to claim 1, characterized in that the estimation is performed in the time domain.

3. Method according to claim 1, characterized in that the estimation is performed in the frequency domain.

4. Method for expanding the bandwidth of a narrowband filtered speech signal, in particular a speech signal transmitted by a telecommunications device, above a first cut-off frequency of the narrowband speech signal,
wherein
a) the narrowband speech signal is subdivided into speech signal time segments (P0.1) and a spectral structure of the speech signal time segment is computed in each case (P1.1),
b) each narrowband speech signal time segment is classified as a voiced sound or as an unvoiced sound (P2.1),
characterized in that
c) enhancements having a spectral structure for expanding the narrowband speech signal in relation to the sound-related classification (P3.1) performed in b), wherein in particular at least for the case of the voiced sound the enhancement is independent of the respective sound,
d) the spectral structure of the narrowband speech signal time segment and the spectral structure of the generated enhancement are combined (P3.1) in time segment sequence such that an expanded spectral structure is produced in each case,
e) a wideband expanded speech signal time segment is generated in each case from the expanded spectral structure (P3.1),
f) a wideband expanded speech signal time segment is generated from the individual wideband expanded speech signal time segments (P6.1).

5. Method according to claim 1 or 3, characterized in that above the first cut-off frequency of the narrowband speech signal
a) the narrowband speech signal is subdivided into speech signal time segments (P0.1) and a spectral structure of the speech signal time segments is computed in each case (P1.1),
b) each narrowband speech signal time segment is classified as a voiced sound or as an unvoiced sound (P2.1),
c) enhancements having a spectral structure for expanding the narrowband speech signal in relation to the sound-related classification (P3.1) performed in b), wherein in particular at least for the case of the voiced sound the enhancement is independent of the respective sound,
d) the spectral structure of the narrowband speech signal time segment and the spectral structure of the generated enhancement are combined (P3.1) in time segment sequence such that an expanded spectral structure is produced in each case,
e) a wideband expanded speech signal time segment is generated in each case from the expanded spectral structure (P3.1),
f) a wideband expanded speech signal time segment is generated from the individual wideband expanded speech signal time segments (P6.1).

6. Method according to claim 4 or 5, characterized in that
the spectral structure of the narrowband speech signal time segment is computed by means of an FFT analysis and the wideband expanded speech signal time segment is generated from the expanded spectral structure by means of an IFFT analysis.

7. Method for expanding the bandwidth of a narrowband filtered speech signal, in particular a speech signal transmitted by a telecommunications device, above a first cut-off frequency of the narrowband speech signal, wherein
a) the narrowband speech signal is subdivided into speech signal time segments (P0.2) and a spectral structure of the speech signal time segments is computed in each case (P1.2, P2.2),
b) each narrowband speech signal time segment is classified as a voiced sound or as an unvoiced sound (P3.2),
characterized in that
c) enhancements having a spectral structure for expanding the narrowband speech signal in relation to the sound-related classification (P4.2) performed in b), wherein at least for the case of the voiced sound the enhancement is independent of the respective sound,
d) the spectral structure of the narrowband speech signal time segments and the spectral structure of the generated enhancement are combined (P4.2) in time segment sequence such that an expanded spectral structure is produced in each case,
e) with regard to the time segment duration, prediction error signal time segments of a wideband prediction error signal corresponding to the narrowband speech signal time segments are generated (P5.2) and a wideband expanded speech signal time segment is generated in each case from the expanded spectral structure and the respective wideband prediction error signal time segment (P6.2, P7.2),
f) a wideband expanded speech signal is generated from the individual wideband expanded speech signal time segments (P10.2).

8. Method according to claim 1 or 3, characterized in that
above the first cut-off frequency of the narrowband speech signal,
a) the narrowband speech signal is subdivided into speech signal time segments (P0.2) and a spectral structure of the speech signal time segments is computed in each case (P1.2, P2.2),
b) each narrowband speech signal time segment is classified as a voiced sound or as an unvoiced sound (P3.2),
c) enhancements having a spectral structure for expanding the narrowband speech signal in relation to the sound-related classification (P4.2) performed in b), wherein at least for the case of the voiced sound the enhancement is independent of the respective sound,
d) the spectral structure of the narrowband speech signal time segments and the spectral structure of the generated enhancement are combined (P4.2) in time segment sequence such that an expanded spectral structure is produced in each case,
e) with regard to the time segment duration, prediction error signal time segments of a wideband prediction error signal corresponding to the narrowband speech signal time segments are generated (P5.2) and a wideband expanded speech signal time segment is generated in each case from the expanded spectral structure and the respective wideband prediction error signal time segment (P6.2, P7.2),
f) a wideband expanded speech signal is generated from the individual wideband expanded speech signal time segments (P10.2).

9. Method according to claim 7 or 8, characterized in that
the enhancement generated in each case for the narrowband speech signal time segments classified as voiced sounds is generated in such a way (P4.2) that the energy of this enhancement is negligible in relation to the total energy of the narrowband speech signal segment.

10. Method according to one of the claims 7 to 9, characterized in that
the enhancement generated in each case for the narrowband speech signal time segments classified as unvoiced sounds is generated in such a way (P4.2) that the energy of this enhancement is not negligible in relation to the total energy of the narrowband speech signal segment.

11. Method according to one of the claims 1, 3 or 4, characterized in that
the enhancement generated in each case for the narrowband speech signal time segments classified as unvoiced sounds is generated in such a way (P4.2) that second filter coefficients of a wideband speech signal time segment are determined from first filter coefficients of the narrowband speech signal time segment on the basis of at least one wideband codebook.

12. Method according to one of the claims 7 to 10, characterized in that
third filter coefficients are computed in each case from the expanded spectral structure (P6.2).

13. Method according to claim 11 or 12, characterized in that
wideband expanded speech signal time segments and hence the wideband expanded speech signal are synthesized by means of the second or third filter coefficients and the wideband prediction error signal time segment (P7.2).

14. Method according to claim 12, characterized in that
a) the third filter coefficients are compared with the entries from a wideband codebook and
b) the entry in the wideband codebook which best matches the third filter coefficients is taken as the basis for the filter coefficient of the synthesis of the wideband expanded speech signal.

15. Method according to claim 4, 5, 7, 8, 9 or 10, characterized in that
the generated enhancement drops, drops exponentially, rises, maintains a constant zero level or maintains a constant level.

16. Method according to claim 4, 5, 7 or 8, characterized in that
the wideband expanded speech signal time segment generated in each case from the expanded spectral structure is high-pass filtered (P4.1, P8.2), the high-pass filtered speech signal time segment is combined with the corresponding narrowband speech signal time segment (P5.1, P9.2) and the wideband expanded speech signal is generated from the individual combined speech signal time segments (P6.1, P10.2).

17. Method for expanding the bandwidth of a narrowband filtered speech signal, in particular a speech signal transmitted by a telecommunications device, above a first cut-off frequency of the narrowband speech signal, wherein
a) the narrowband speech signal is subdivided into speech signal time segments (P0.3),
b) each narrowband speech signal time segment is classified as a voiced sound or as an unvoiced sound (P1.3),
characterized in that
c) the narrowband speech signal time segments are processed non-linearly (P2.3) in such a way that in each case a modified speech signal time segment is generated which on the one hand contains the respective essentially unmodified narrowband speech signal time segment and on the other hand contains signal components generated by the non-linear signal processing above the first cut-off frequency,
d) the modified speech signal time segments are filtered differently (P3.3) in relation to the sound-related classification performed in b) in such a way that wideband expanded speech signal time segments and hence a wideband expanded speech signal are produced from the modified speech signal time segments.

18. Method according to claim 1 or 2, characterized in that
above the first cut-off frequency of the narrowband speech signal
a) the narrowband speech signal is subdivided into speech signal time segments (P0.3),
b) each narrowband speech signal time segment is classified as a voiced sound or as an unvoiced sound (P1.3),
c) the narrowband speech signal time segments are processed non-linearly (P2.3) in such a way that in each case a modified speech signal time segment is generated which on the one hand contains the respective essentially unmodified narrowband speech signal time segment and on the other hand contains signal components generated by the non-linear signal processing above the first cut-off frequency,
e) the modified speech signal time segments are filtered differently (P3.3) in relation to the sound-related classification performed in b) in such a way that wideband expanded speech signal time segments and hence a wideband expanded speech signal are produced from the modified speech signal time segments.

19. Method according to claim 17 or 18, characterized in that
the signal components generated in each case by the non-linear signal processing for the narrowband speech signal time segments classified as voiced sounds are generated in such a way (P2.3) that the energy of the respective signal component is negligible in relation to the total energy of the narrowband speech signal time segment.

20. Method according to one of the claims 17 or 18, characterized in that
the signal components generated in each case by the non-linear signal processing for the narrowband speech signal time segments classified as unvoiced sounds are generated in such a way (P2.3) that the energy of the respective signal component is not negligible in relation to the total energy of the narrowband speech signal time segment.

21. Method according to one of the claims 17 to 20, characterized in that
the signal components are generated by spectral mirroring.

22. Method according to one of the claims 4 to 21, characterized in that
the narrowband speech signal time segments are chosen to be of equal length.

23. Method for expanding the bandwidth of a narrowband filtered speech signal, in particular a speech signal transmitted by a telecommunications device, below a second cut-off frequency of the narrowband speech signal,
wherein
a) a prediction error signal of the narrowband speech signal is computed (P0.4, P0.5)
characterized in that
b) the filter characteristic of the narrowband filtered speech signal is estimated on the basis of the prediction error signal (P1.4, P1.5),
c) based on the filter characteristic, a process for processing the narrowband speech signal is controlled in such a way (P2.4, P2.5, P3.5, P4.5, P5.5) that a wideband expanded speech signal is generated.

24. Method according to one of the claims 1 to 22, characterized in that
below the second cut-off frequency of the narrowband speech signal,
a) a prediction error signal of the narrowband speech signal is computed (P0.4, P0.5)
b) the filter characteristic of the narrowband filtered speech signal is estimated on the basis of a prediction error signal of the narrowband speech signal,
c) based on the filter characteristic, a process for processing the narrowband speech signal is controlled in such a way (P2.4, P2.5, P3.5, P4.5, P5.5) that a wideband expanded speech signal is generated.

25. Method according to claim 23 to 24, characterized in that
the filter characteristic of the narrowband filtered speech signal is estimated by a comparison of the partial energies of the prediction error signal measured in at least two frequency ranges and from the resulting energy differences conclusions are drawn as to the filter characteristic of the narrowband filtered speech signal.

26. Method according to one of the claims 23 to 25, characterized in that
a) an inverse filter characteristic is determined on the basis of the estimated filter characteristic,
b) the narrowband speech signal is equalized in the processing process in accordance with the inverse filter characteristic.

27. Method according to one of the claims 23 to 25, characterized in that
in the processing process
a) the base frequency and/or at least one harmonic of the narrowband filtered speech signal is reconstructed by non-linear processing of the narrowband filtered speech signal taking into account control parameters determined on the basis of the estimated filter characteristic,
b) the speech signal reconstructed in relation to the base frequency and/or at least one harmonic is bandpass or low-pass filtered,
c) the bandpass or low-pass filtered, reconstructed speech signal and the narrowband filtered speech signal are combined, in particular added.

28. Method according to claim 27, characterized in that the narrowband filtered speech signal is filtered prior to the non-linear signal processing.
